(19) United States
(12) Patent Application Publication
(10) Pub. No.: US 2013/0265276 A1
(43) Pub. Date: Oct. 10, 2013

(54) MULTIPLE TOUCH SENSING MODES

(71) Applicants: Amjad T. Obeidat, San Francisco, CA (US); Aleksandar Pance, Saratoga, CA (US)

(72) Inventors: Amjad T. Obeidat, San Francisco, CA (US); Aleksandar Pance, Saratoga, CA (US)

(73) Assignee: Amazon Technologies, Inc., Reno, NV (US)

(21) Appl. No.: 13/621,830

(22) Filed: Sep. 17, 2012

Related U.S. Application Data
(60) Provisional application No. 61/621,809, filed on Apr. 9, 2012.

(51) Int. Cl. G06F 3/044

(52) U.S. Cl. CPC G06F 3/044
USPC 345/174

(57) ABSTRACT

A touch controller of a computing device can adjust various modes of operation of a touch panel in order to conserve resources on the device. The touch controller can dynamically adjust a rate at which touch sensors are scanned, or can scan touch sensors for the display panel using a different mode than for a single input button or other such element. The touch controller can also operate in a low power mode while the device is in standby, and then activate a high power mode of operation upon detecting an input such as a double tap. The touch controller can also alternate between low and high power modes of operation based at least in part upon a current application executing on the device.

### CLAIM OF PRIORITY

This patent application claims priority to U.S. Provisional Patent Application No. 61/621,809 filed on Apr. 9, 2012, entitled “HYBRID TOUCH SENSING MODES” which is incorporated by reference herein in its entirety.

### BACKGROUND

People are increasingly relying on computing devices, such as tablets and smart phones, which utilize touch sensitive displays. These displays enable users to enter text, select displayed items, or otherwise interact with the device by touching and performing various actions with respect to the display screen, as opposed to other conventional input methods. Devices are increasingly offering touch screens that can detect multiple touches, such as where a user uses more than two fingers to provide concurrent input. Such approaches typically consume a significant amount of power which is limited due to the battery capabilities of the device.

### BRIEF DESCRIPTION OF THE DRAWINGS

Various embodiments in accordance with the present disclosure will be described with reference to the drawings, in which:

FIG. 1 illustrates an example of a user providing a single touch input to a device in accordance with various embodiments.

FIG. 2 illustrates an example of a user providing a multi-touch input to a device in accordance with various embodiments.

FIG. 3 illustrates an example cross-section of a sensor array on a display element that can be utilized in accordance with various embodiments;

FIG. 4 illustrates an example of a portable computing device utilizing a grid of sensor lines that can be used to detect objects coming in contact with the touch screen display, in accordance with various embodiments;

FIG. 5 illustrates an example of a mutual capacitance screen being used in a proximity detection mode that is used to sense objects in proximity to the touch screen display, in accordance with various embodiments;

FIG. 6 illustrates an example of a self-capacitance screen being used in a proximity detection mode that is used to sense objects in proximity to the touch screen, in accordance with various embodiments;

FIG. 7 illustrates an alternative example of a self-capacitance screen being used in proximity detection mode to sense objects in proximity to the touch screen, in accordance with various embodiments;

FIG. 8 illustrates an example of a process for operating a touch controller in multiple modes of detection, in accordance with various embodiments;

FIG. 9 illustrates an example of a process for adjusting a scan rate of a touch controller in accordance with various embodiments;

FIG. 9B illustrates an example of a process that can be used to operate the touch controller in a number of different sub-modes, in accordance with various embodiments;

FIG. 10 illustrates front and back views of an example portable computing device that can be used in accordance with various embodiments;

FIG. 11 illustrates an example set of basic components of a portable computing device, such as the device described with respect to FIG. 10; and

FIG. 12 illustrates an example of an environment for implementing aspects in accordance with various embodiments.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Systems and methods in accordance with various embodiments of the present disclosure may overcome one or more of the aforementioned and other deficiencies experienced in conventional approaches to providing input to, or determining information for, a computing device. In particular, various approaches discussed herein enable a touch sensitive display or other such element to operate in different modes at different times, in order to attempt to conserve power during time periods when certain functionality is not needed. In addition, various approaches described herein use a number of electric field and capacity sensing techniques that enable the computing device to detect objects (e.g., a human finger) coming within proximity of the touch sensitive display before the objects make any physical contact with the computing device.

In accordance with an embodiment, a computing device (e.g., mobile phone, electronic reader or tablet computer) is described that includes a touch screen display and input assembly capable of detecting objects (e.g., human finger) in proximity of the touch screen or in physical contact with the touch screen. The touch screen includes a sensor layer (or several sensor layers) configured to detect changes in capacitance or changes in electric field caused by the objects in proximity of the display screen. The device further includes a touch controller, such as a low power microcontroller dedicated to sensing touches and/or objects. The touch controller is configured to analyze the changes in capacitance and/or electric field in order to detect the presence and location of objects in proximity of the display screen.

In accordance with an embodiment, the touch controller is capable of operating in at least two modes of operation. The first mode, an “active” or “high-power” mode, can utilize mutual capacitive touch sensing that enables tracking of multiple finger touches and gestures. The second mode, an “idle” or “low-power” mode can instead utilize self-capacitance touch sensing. This low-power mode can be utilized when single touch input will likely be utilized, and in some cases, can be used to bring the device back from a standby or similar mode into a high power mode where mutual capacitive sensing is used, in order to allow for multi-touch input. For example, when the computing device is in the “idle” mode, the touch controller can operate in self-capacitance mode to save on battery power. If the touch controller detects a specified event or interaction of objects with the display screen (e.g., a user double tapping the display screen), the device can switch to begin scanning in “high-powered” mutual capacitance mode, where multi-touch events are more accurately detected. The self-capacitance mode and the mutual capacitance mode will be described in further detail later in this disclosure.

In accordance with some embodiments, the touch controller is further capable of adjusting the scan rate used to scan the sensors of the display screen. For example, when the device is in the low-power or idle mode, or when the device is executing applications that are not capable of using multi-touch input, the touch controller may reduce the scan rate of the sensors in order to reduce power usage of the device. Similarly, when the device is awakened or when the application executing on the device is capable of utilizing multi-touch sensing, the scan rate can be increased to improve the accuracy of detecting multiple touch events. The adjusting of scan rates can be performed in the context of both the mutual capacitance mode and the self-capacitance mode of operation.

In accordance with some embodiments, the touch screen further provides a “proximity detection” or “hover detection” mode that is capable of sensing objects that are in the proximity of the display screen but which have not made physical contact with any part of the display screen. A number of different approaches are described herein for enabling the proximity detection mode, in the context of both mutual capacitance mode of operation and self-capacitance mode of operation.

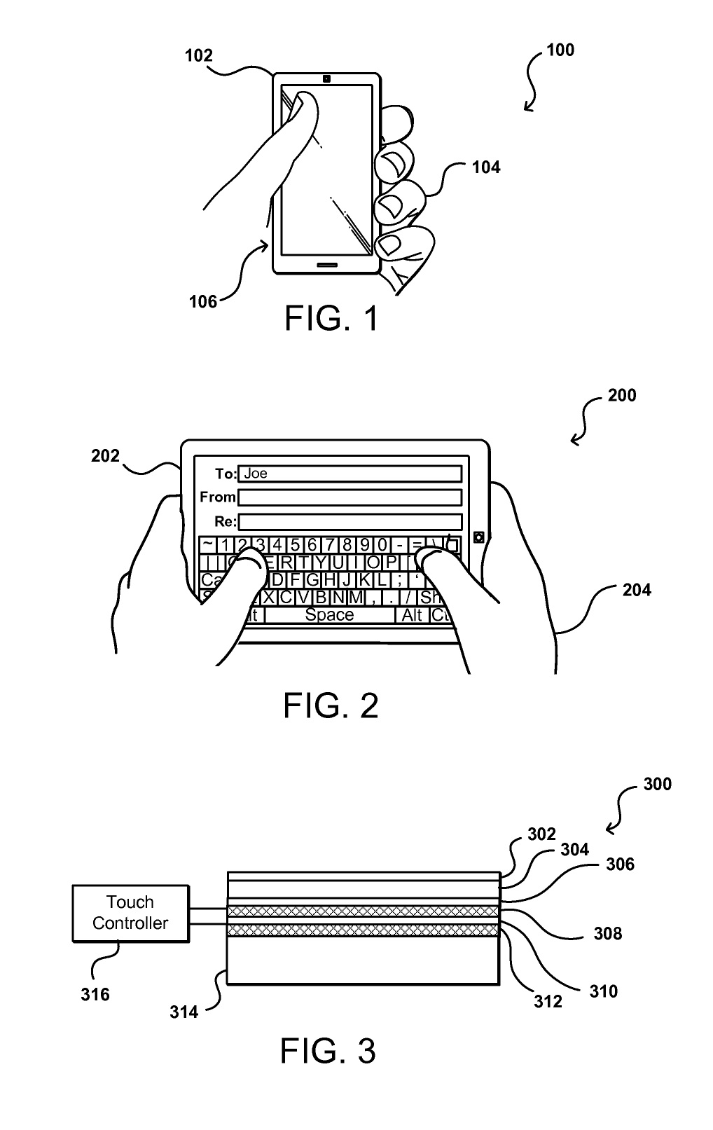

FIG. 1 illustrates an example situation 100 wherein a user is holding a portable computing device 102 in the user's hand 104. The computing device 102 can be any appropriate device, such as a smart phone, tablet computer, or personal data assistant, among other such options. The computing device 102 has a capacitive touch screen 106 that can detect when a portion of a user's hand 104, such as a tip of a user's finger or thumb, comes in contact with the touch screen (or at least within a detectable distance of the screen). In this example, the user is providing input with only the user's thumb, such that an approach capable of determining a single input can be utilized. In some cases, however, the user might want to use multiple concurrent inputs to the touch screen. For example, FIG. 2 illustrates a situation where a user is holding a device 202 (the same or a different device from FIG. 1) with two hands 204 and concurrently using thumbs on both hands to enter text to the device through the touch screen. Many other such multi-touch input approaches can be used as well, such as a user using all ten fingers, a combination of fingers and objects, or other such input variations. By way of example, some applications allow the user to utilize “pinching” (or other multi-touch gestures) using two or more fingers to adjust the size of various objects displayed on the touch screen. In order to allow for such variance, a touch screen in accordance with various embodiments should be able to support multiple concurrent inputs.

Touch screens can utilize a number of different approaches to enabling touch input, including but not limited to resistive or capacitive touch based technology. As known in the art, a capacitive touch screen can be a self-capacitance or a mutual-capacitance screen, among other such options. A self-capacitance screen typically includes a layer of capacitive material, where in some embodiments, capacitors or capacitive regions are arranged in the layer according to a coordinate system. For example, a plurality of sensor lines can be arranged in a grid having multiple rows and columns (or other formation), where each sensor line is treated as a conductor that has a certain amount of capacitance. When an object (e.g., human finger) comes in proximity or contact with the conductor, the object causes a change in capacitance of the sensor line(s). This capacitive change caused by the object can be measured in the various rows and columns using a current meter (or other such component), enabling the location of the touch to be determined (e.g., by determining the intersection of the affected sensor lines in the grid). Such an approach has relatively low power requirements and produces a relatively strong signal, but in some cases cannot accurately resolve multiple touch locations, especially when more than one or two objects are simultaneously making contact with the screen. This can result in inaccurate touch location determinations or ghosting, among other such issues.

In various embodiments, a mutual capacitance based approach can utilize the same set of sensor lines or a different set of sensor lines that are configured to act as transmitters and receivers. For example, each column of the sensor grid can be configured as a transmitter that transmits an electrical signal (e.g., produces an electric field) and each row of the sensor grid can be configured as a receiver that receives that electrical signal. When an object such as a finger comes into proximity with the screen, the object causes a change in the amount of signal that the receiver is receiving. For example, the finger touching the screen can reduce the amount of signal being received by the receiver. Based on this change in signal, the location of the touch can be determined. In addition, multiple touches (e.g., 3 or more simultaneous touches) can be accurately located on the touch screen by using mutual capacitance. Thus, while mutual capacitance tends to be more accurate than self-capacitance, mutual capacitance also typically uses more power than self-capacitance (e.g., for transmitting/receiving the electrical signal).

FIG. 3 illustrates an example cross-section of an arrangement 300 wherein touch sensors are placed on a display element 314, such as an LCD or OLED display, in order to provide a touch-sensitive display. A top, anti-reflective coating layer 302 is positioned over a protective cover element 304 in this example, which in some embodiments can be attached to the sensor layers using a bonding 306 layer of an appropriate adhesive material. A first touch sensor layer 308 is provided, which can include a grid of sensor lines, diamond pattern sensor lines, a set of parallel transparent touch sensors (running orthogonal to the plane of the figure), or another such configuration. The first sensor layer can be positioned on a layer of material 310, such as a thin film separator, that separates the first touch sensor layer from a second transparent touch sensor layer 312. The second touch sensor layer can have a corresponding set of grid, diamond, or parallel line (running parallel to the plane of the figure) pattern. As should be understood, various other arrangements and components can be used as well within the scope of the various embodiments, and in some embodiments, the sensor layers may be provided using one or more additional layers as well.

In this example, a touch controller 316 is in electrical communication with the touch sensor layers 308, 310. The touch controller can cause a driving voltage to be applied to one of the layers, such as the first layer 308. A user bringing a finger close to, or in contact with, the top layer 302 can cause a change in the local electrostatic field around the area of the touch, thus reducing the mutual capacitance at the capacitors at or near the area of the touch. The capacitance change at each capacitor point can be determined by measuring the voltage on the second touch sensor layer 312, or the sensing pattern. The touch controller can determine the appropriate input information, including information such as number, location, approximate size, and duration of a touch, and can provide that information to an application executing on at least one main processor of the device. Mutual capacitance can enable accurate multi-touch operation, such that a user can provide concurrent input using multiple fingers or objects, but such an approach frequently draws significantly more power than a self-capacitance approach.

Approaches in accordance with various embodiments can support multiple operational modes that provide multi-touch functionality as needed, but conserve power in other situations. In at least some embodiments, two modes of operation are provided for use with a touch controller. A first mode, an “active” or “high-power” mode, can utilize mutual capacitive touch sensing that enables tracking 10-finger touches and gestures. A second mode, an “idle” or “low-power” mode can instead utilize self-capacitance touch sensing, or operate at a lower frame rate. A low-power mode can be utilized when single touch input will likely be utilized, and in some cases can be used to bring the device back from a standby or similar mode into a high power mode where mutual capacitive sensing is used, in order to allow for multi-touch input.

In various embodiments, a low power mode can be used when a device is in a standby, “sleep”, or other such state where the display and other device components may be inactive or in a low power state. A user, manufacturer, developer, or other such entity can define an input interaction to use with the touch screen which would be used to wake the device. For example, a double tap using a single finger can be detected by the device when in a low power mode, which can then cause the device to enter a high power mode. The touch controller can remain active in the low power mode, periodically scanning the touch panel for a double-tap event using self-capacitance. The event can be defined by several potential parameters, such as may include the touch size of each tap, the time difference between the first and a second tap, and the location of each tap, among other such aspects. Upper and lower limits can be set for all parameters in order to reject false events and accept true double tap events. When the controller determines, based on a set of well-defined logic operations, for example, that a double-tap event has occurred, the touch controller can send an interrupt signal (or other such trigger) to the host application processor, such that the device can go into a high-power, mutual-capacitive sensing state. In some embodiments, the interaction that causes the controller to switch between the modes can be user configurable. For example, the user can select between multiple different events that cause the device to switch between modes or the user can be able to adjust the parameters of the double tap event, such as to adjust the speed or duration for which a double tap is recognized. For example, a range of times can be defined, such as with a lower limit on the order of about 100 ms and an upper limit on the order of about 0.5 seconds. Further, the double tap location can be limited to a portion of the display panel, in order to reduce the area that must be scanned and further reduce power requirements. In order to prevent false input, the device can also analyze the size of the tap. For example, the area of contact detected for a user's fingertip will be within a certain size range, such as from about 5 mm to about 10 mm. Touches with sizes outside this range might be rejected at least for purposes of waking the device, such as where the device is in a purse or backpack and might occasionally have something come into contact with the touch screen that affects the capacitance, but is not the size of a human fingertip.

In various alternative embodiments, other input actions can be defined to be used with the touch screen in order to wake the device. For example, a double tap with two fingers can be defined which can be detected using self-capacitance. In this example, the computing device can distinguish that the double tap was caused by two objects (e.g., fingers) touching the screen simultaneously (or substantially simultaneously). Using this approach may require more complex detection algorithms, however, it may further decrease the likelihood that objects other than the user's finger (e.g., accidentally touching the thigh of the user) would wake the device. In various embodiments, a number of other actions can be defined to place the device into “active” mode, including but not limited to a user drawing a plus sign or an “X”, dragging finger from left-to-right or top-to-bottom and the like. In some embodiments, the user enabled to select one of the plurality of events or interactions that cause the device to switch between the self-capacitance and mutual capacitance mode of operation.

In some embodiments, the touch controller can be configured, through firmware or otherwise, to enable the touch panel to operate in a dual mode supporting both self-capacitance and mutual-capacitance modes. In such a mode, the touch controller can first scan the touch panel at a high frame rate to maintain an acceptable user experience, then can switch to a self-capacitance mode for a fast scan of one or more self-capacitance sensors that may be used as buttons (e.g., home button) or sliders on the device but outside the area of the display. These “soft” buttons are common on certain conventional devices, but scanning those single input buttons with a mutual capacitance process may waste power on the device. A single touch sensor (or pair of touch sensors) might be used for each soft button, which does not actually have any mechanical moving parts and functions more like a touch “point.” The controller thus can alternate between a mutual-capacitance mode used to support multiple touches on the display panel, and a self-capacitance mode used to support the single touch operation of one or more soft buttons on the device. In some embodiments, when scanning, the touch panel and the soft button are scanned in a time period that is shorter than the refresh rate of the screen, which can result in a scan period of less than around 16 ms for some devices. An acceptable signal to noise ratio also be maintained, as a high speed scan may introduce noise when not as much time is spent determining input at each location.

In other embodiments, the device can selectively switch between mutual and self-capacitance modes for the touch panel. For example, certain applications, such as Solitaire, require only one or two finger operation while the device is active. The operating system can identify these applications to the host, such as by receiving instructions from the application. When these types of applications are running, the touch controller can operate in the low-power, self-capacitance mode where the touch controller can detect one or two simultaneous touches on the screen. For this operation, the touch panel scanning method can be different from the scanning method used when the device has been wakened and placed into active scanning mode. A device thus can operate in self capacitance mode to conserve power when the active application is a type that has been indicated as not supporting or requiring multiple touch input. This mode can also be joined with the dual scanning mode discussed above.

In some embodiments, the device can effectively throttle the active mode of the touch controller. For example, the touch controller can support mutual capacitance touch sensing in a high power mode. In this high power mode, the host or the controller can monitor touch statistics, such as the number of touches over a period of time (e.g., per millisecond) for a sliding window in time. If the controller determines that the number of touches is lower than a certain fraction of the touch scan rate, the scan rate can be reduced to save power. Similarly, if the controller determines that the number of touches has once again risen above another threshold, the scan rate can be increased again to ensure that a potential multi-touch event is not missed. In various embodiments, the statistics monitored by the touch controller can include any data about the changes in the capacitance measured by the sensors which may be relevant to determining information about the user touching the display screen. For example, the touch statistics may be the number of touches (e.g., single touches, multi-touches, etc.) detected over a predetermined period of time, a running average of the touches, number of touches at particular time of day, touches according to a particular application being executed, information about the relationship between multi-touches and single touches, and the like.

In accordance with an embodiment, the throttling mode can also be enabled through knowledge of which application is running on the device. For example, if the user is watching a video, the likelihood of a multiple touch event may be substantially reduced and the controller can reduce the touch scan rate accordingly. Once the video is over or the user has initiated another application, the controller can once again increase the scan rate. By adjusting the scan rate in this manner, the touch controller is able to save on battery power of the device.

In accordance with an embodiment, when in throttling mode, the touch controller can continually scan for touches, movement, accelerations of touches, or other such events, at a slower rate than the rate used in active mode. For example, as the rate of touches decreases, the device can slowly decrease the rate at which the touch controller scans the touch sensors. As the touch frequency increases, the controller can increase the scan rate, either gradually or directly back to the fastest scan rate in order to ensure that no touch information is missed. Similarly, if a user opens an application that generally uses multiple touch input, the scan rate can be increased accordingly. The operating system in such an instance can pass information about the application to the host processor, an application processor, or another such component, which can provide the touch controller with information about the type of input needed for that application. The use of dynamic scan throttling can help minimize the amount of power used for a mutual capacitance mode, or even a self capacitance mode in some embodiments. The throttling decisions in some embodiments thus can be a combination of touch information coming from the touch screen and application-specific information coming from the operating system.

In some embodiments, a device in throttling mode can periodically perform a quick scan over a period of time in order to ensure that touches are not being missed. For example, the controller may throttle the scan speed down to 10% of the maximum rate, and after a determined period of time has lapsed, increase the rate back up to the full rate, even if no increase in touch frequency has been detected. This may decrease the likelihood of missing multi-touch events while still obtaining some power savings.

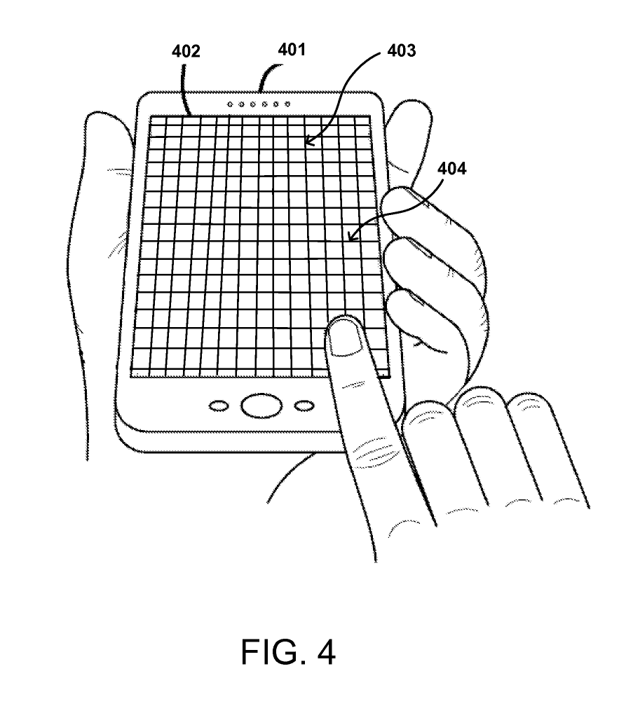

FIG. 4 illustrates an example of a portable computing device 401 utilizing a grid of sensor lines that can be used to detect objects coming in contact with the touch screen display, in accordance with various embodiments. In the illustrated embodiment, the sensor lines are arranged in a grid formation 402 that includes a number of rows 404 and a number of columns 403. The grid can cover substantially the entire touch screen or display screen of the mobile computing device 401.

In accordance with an embodiment, when operating in the mutual capacitance mode, the columns 403 of the grid can be configured to be transmitters that transmit an electronic signal (e.g., emit an electric field) and the rows 404 can be configured as receivers that receive the electronic signal. When an object, such as a finger, is present on the screen, the object reduces the amount of signal that the receiver is receiving. Based on such reduced signal being detected the touch controller can determine the location of the object on the screen at the intersection of the transmitter and receiver. Mutual capacitance thus enables the controller to determine the locations of multiple touches based on changes in capacitance at each intersection.

When operating in self-capacitance mode, there are no transmitters or receivers. Instead, each sensor line is treated as a conductive metal plate. In this mode, the touch controller is capable of measuring the base self-capacitance of each sensor line. When an object, such as a finger, touches one or more of the sensor lines (or comes into close proximity with the sensor lines), the capacitance of the object gets added to the capacitance of the sensor line. The line thus sees an increase in capacitance, which is detected by the touch controller. Based on the intersection of the lines which have seen an increase in capacitance, the touch controller is able to determine the location of the object on the screen. Thus, in self-capacitance mode, the controller scans each individual sensor line for changes in capacitance, in contrast to scanning for changes in capacitance at each intersection between two sensor lines when operating in mutual capacitance mode.

It should be noted that in various embodiments, the plurality of sensors of the touch screen display can be contained in a single sensor layer or can be distributed between multiple sensor layers. For example, in some embodiments, the sensor rows may be contained in one layer, while the sensor columns are contained in a separate sensor layer. In other embodiments, both rows and columns are contained in the same layer.

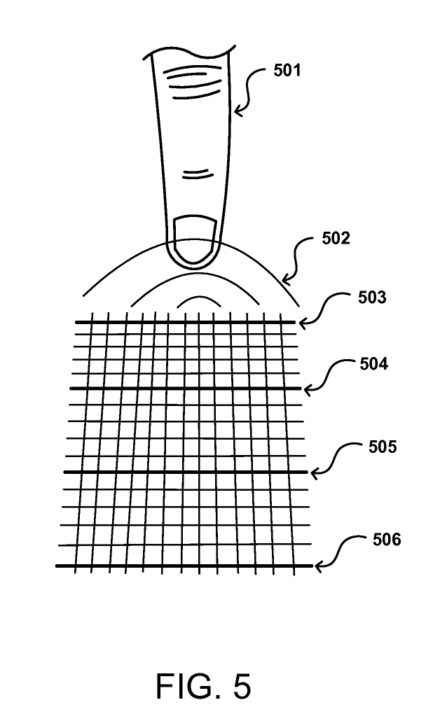

FIG. 5 illustrates an example of a mutual capacitance screen being used in a proximity detection mode that is used to sense objects in proximity to the touch screen display, in accordance with various embodiments. In the illustrated embodiment, some of the rows that would normally be a receiver are converted to be transmitters. For example, the row at the top of the screen 503 can be configured to the transmitter and the row 506 at the bottom of the screen can be configured to be a receiver. As such, the transmitters are separated in space from the receivers by one or more inactive sensor lines. This creates a larger distance and therefore a larger range of electric field 503 between the transmitter line 503 and the receiver line 506. This also causes the electric field lines to extend further in the direction perpendicular to the screen, such that the finger 501 entering the electric field 502 can cause an effect that is detectable by the receiver 506. In this example, the finger can be detected by the receiver even before the finger makes any physical contact with the screen, due to the extended electric field 502.

As an alternative to making one row a receiver and one row a transmitter, the touch controller can configure several transmitters and several receivers. Activating more rows as transmitters and receivers in this manner can create a stronger electric field 502 but one that does not extend as far as if only the top and bottom rows were activated. For example, as shown in this illustration, rows 503 and 506 can both be configured to be transmitters and rows 504 and 505 can be configured to act as receivers (or vice versa).

In some embodiments, this activation of additional rows can be performed in response to detecting an approaching object, such as finger 501. Thus, by incrementally activating more and more rows (and/or columns) as the object approaches, the touch controller may begin to determine the location of the object before it actually makes contact with the screen. While the location may not be as precise as the mutual capacitance sensing described with reference to FIG. 3, the touch controller can at least determine an approximate location of the object before it touches the screen, which may be useful in certain applications.

It should also be noted that while FIG. 5 refers to activating rows, it will be evident to one of ordinary skill in the art that columns can easily be used in the same manner described herein i.e. be selectively activated as transmitters/receivers instead (or in addition to) the rows. In addition, various combinations of rows and columns can be configured to be transmitters and/or receivers in accordance with the technique illustrated above. For example, the topmost row and the leftmost column can be configured to act together as a transmitter, while the bottommost row and the rightmost column can be configured to act together as a receiver. This would still allow the device to detect objects within proximity of the touch screen without the objects actually touching the screen.

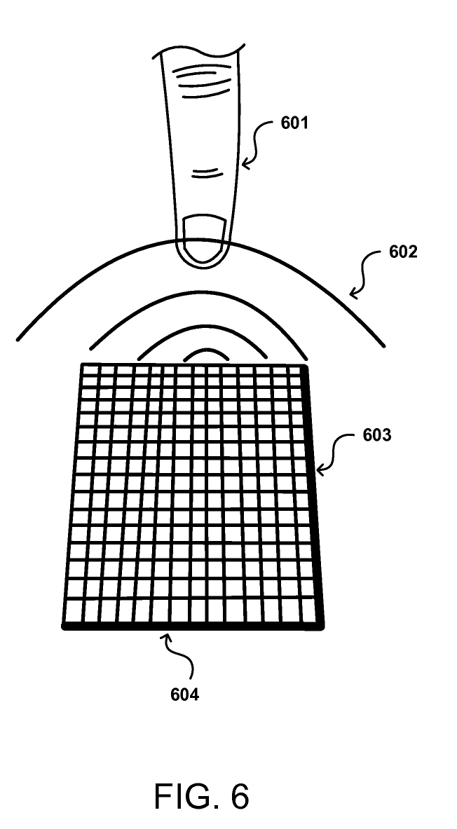

FIG. 6 illustrates an example of a self-capacitance screen being used in a proximity detection mode that is used to sense objects in proximity to the touch screen, in accordance with various embodiments. In the illustrated embodiment, the rows and columns are shorted by connecting all of the rows 603 and all of the columns 604 to a single self-capacitance detection circuit. In this case, instead of seeing a capacitor comprised of a single row and a single column (as in conventional self-capacitance techniques), the detection circuit sees a much bigger capacitor that is made up of the combination of all rows and all columns. This capacitor is effectively the size of the entire touch screen.

In this example, the combined capacitor covers a larger area, has a larger capacitance, and is emanating electric fields 502 that may be used to detect objects (e.g., finger) 501 that are in the proximity of the screen without actually making physical contact with the screen. For example, as a finger or other object is approaching the screen, the capacitance of the combined capacitor will increase from a larger distance than what would be achieved by using conventional single row/column capacitors.

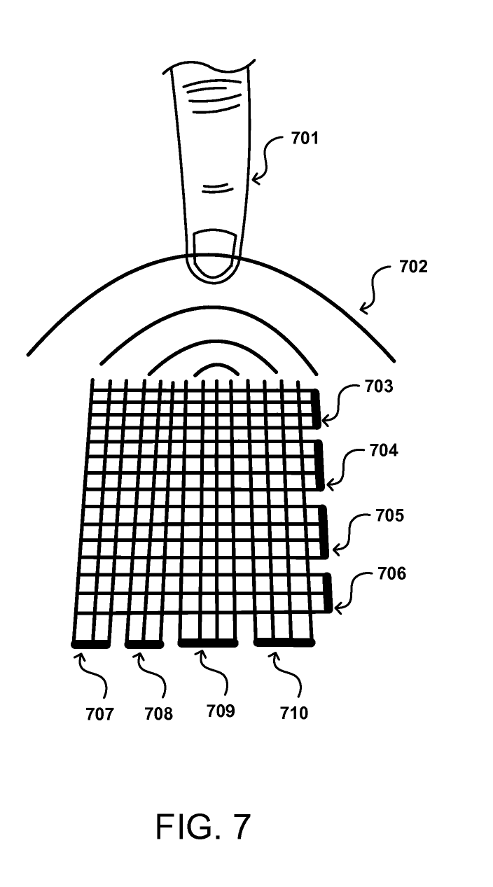

FIG. 7 illustrates an example of using self-capacitance to detect the location of an object in proximity to the touch screen that is not making physical contact with the touch screen, in accordance with various embodiments. In this illustrated embodiment, as the finger 701 is approaching the screen, the signal 702 (e.g., increase in capacitance of the circuit) can be increasing. In this case, the touch controller can switch from using all of the rows and columns being shorted together (as illustrated in FIG. 6) to shorting together a specified number of rows and specified number of columns. For example, as illustrated in FIG. 7, the touch controller can begin to short 3-4 rows (703, 704, 705, 706) at a time and 3-4 columns (707, 708, 709, 710) at a time. This can create a 4×4 grid of large capacitors that can be used to begin to determine the actual location of the finger approaching the screen before it has made contact with the screen.

In accordance with an embodiment, the process of interconnecting or shorting multiple rows and multiple columns can be gradual. For example, as the finger 701 approaches the screen, the touch controller may first detect that the signal has increased past a first threshold and switch the configuration to interconnect every 5 rows and 5 columns. As the finger gets even closer to the screen, the signal crosses a second threshold, and the touch controller may begin to interconnect every 3 rows and every 3 columns. Any number of variations of this method is possible within the scope of the present disclosure.

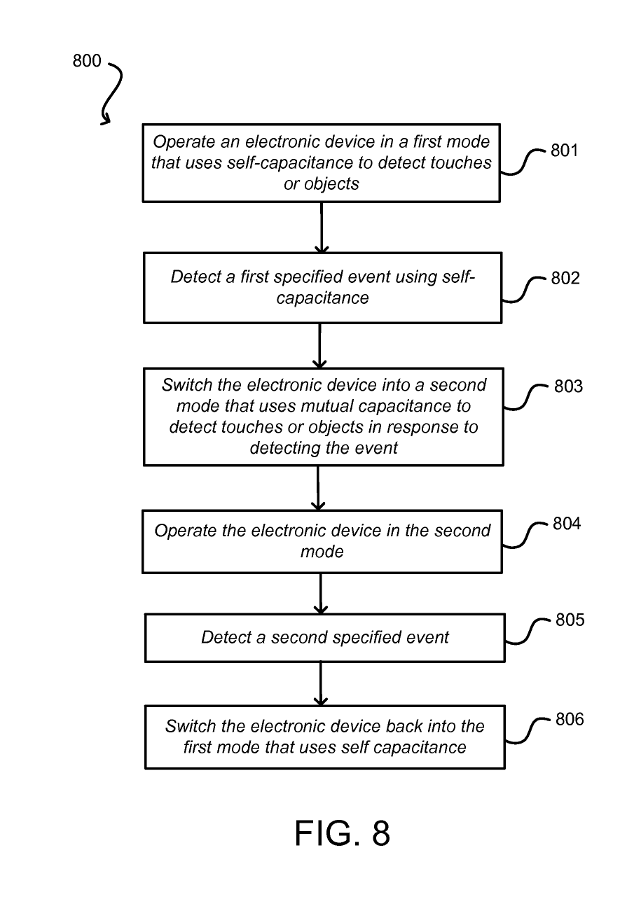

FIG. 8 illustrates an example of a process 800 for operating a touch controller in multiple modes of detection, in accordance with various embodiments. Although this figure may depict functional operations in a particular sequence, the processes are not necessarily limited to the particular order or operations illustrated. One skilled in the art will appreciate that the various operations portrayed in this or other figures can be changed, rearranged, performed in parallel or adapted in various ways. Furthermore, it is to be understood that certain operations or sequences of operations can be added to or omitted from the process, without departing from the scope of the various embodiments. In addition, the process illustrations contained herein are intended to demonstrate an idea of the process flow to one of ordinary skill in the art, rather than specifying the actual sequences of code execution, which may be implemented as different flows or sequences, optimized for performance, or otherwise modified in various ways.

In operation 801, the electronic device is operated in a first mode that uses self-capacitance to detect touches or objects. This mode may be the idle mode, allowing the device to operate at reduced power, saving on battery life. The self-capacitance sensing utilized by this mode can accurately detect single touches, but may not be as accurate for detecting multi-touch events.

In operation 802, the device detects a first specified event using the self-capacitance sensing. For example, the specified event or action may be a double tap performed by the user on the touch screen. Alternatively, the specified event or action may be a swipe from left to right or a swipe from top to bottom performed by the user.

In operation 803, upon detecting the event, the electronic device switches into a second mode that uses mutual capacitance sensing to detect touches or objects. This can be the awake or high-power mode in which the device is capable of more accurately detecting multi-touch events but is also utilizing more battery power.

In operation 804, the device may continue to operate in the second mode, until a second specified event is detected. Once the second event is detected (operation 805), the electronic device can switch back into the first mode of operation that uses self-capacitance. For example, the second event or action may be the user pressing a “hibernate” button or making gesture instructing the device to go into low-power standby mode. Alternatively, the second event may be a lapse of a specified period of time during which the user has provided no input to the device. In this manner, the electronic device can switch back and forth between the multiple modes of operation.

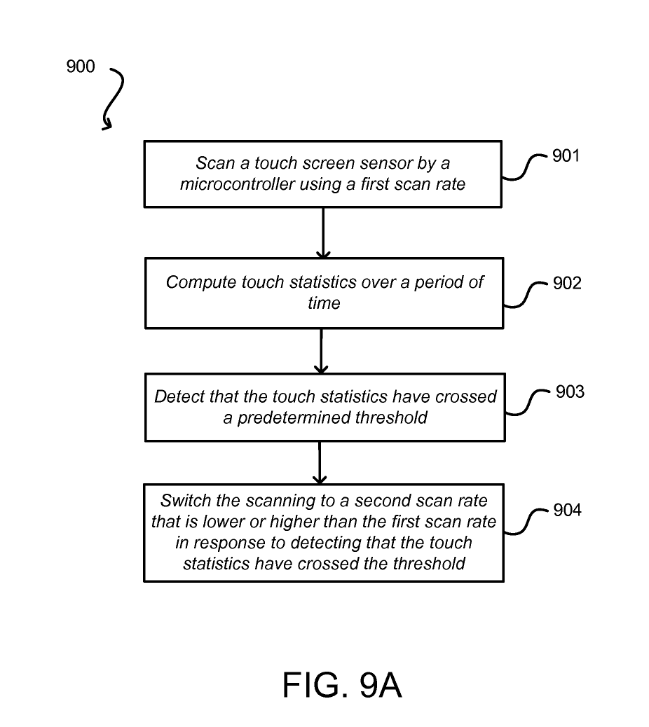

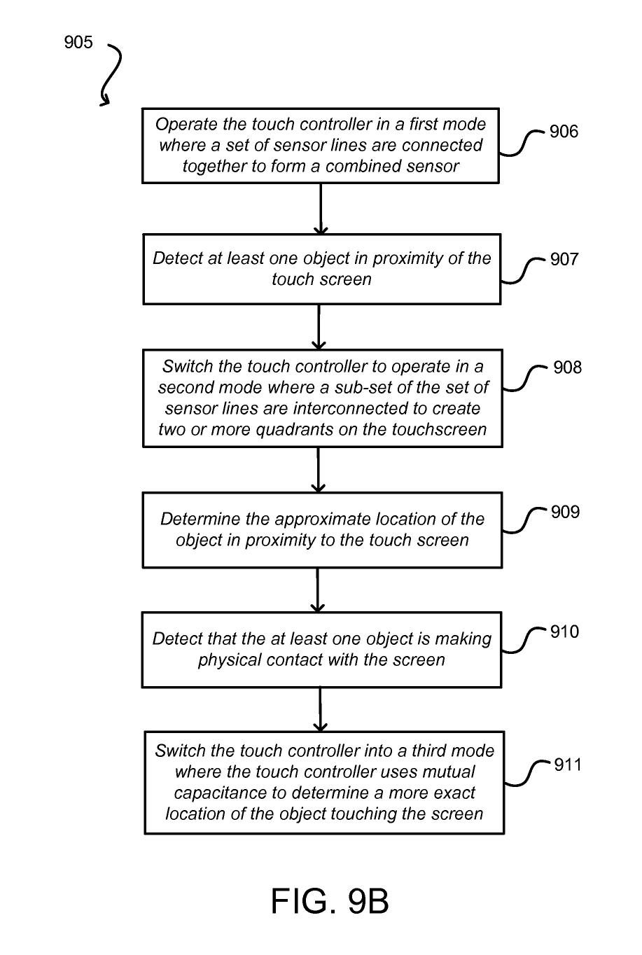

FIG. 9A illustrates an example of a process 900 for adjusting a scan rate of a touch controller in accordance with various embodiments.

In operation 901, the touch screen is scanned by the microcontroller (e.g., touch controller) using a first scan rate. In operation 902, the touch controller can also maintain touch statistics over a period of time. If the touch controller detects that the touch statistics being monitored have reached a predetermined threshold (operation 903), the touch controller can switch the scanning to a second scan rate that is lower or higher than the first scan rate (operation 904). For example, when in idle mode, the touch controller can continually scan for touches, movement, accelerations of touches, or other such events, at a slower rate than the rate used in active mode. As the rate of touches decreases, the device can slowly decrease the rate at which the touch controller scans the touch sensors. As the touch frequency increases, the controller can increase the scan rate, either gradually or directly back to the fastest scan rate in order to ensure that no touch information is missed. Similarly, if a user opens an application that generally uses multiple touch input, the scan rate can be increased accordingly. The operating system in such an instance can pass information about the application to the host processor, an application processor, or another such component, which can provide the touch controller with information about the type of input needed for that application.

FIG. 9B illustrates an example of a process 905 that can be used to operate the touch controller in a number of different sub-modes, in accordance with various embodiments.

In operation 906, the touch controller is operating in a first mode where all of the sensor lines are interconnected (e.g., multiplexed, merged, etc.) to form a single touch sensor capable of detecting objects that are within the proximity of the touch screen but which have not yet made physical contact with the screen. This first mode can be a sub-mode of the self-capacitance mode, as previously described with reference to FIG. 6 for example. By interconnecting all of the sensor lines in this manner, the touch controller is able to produce a larger composite sensor and increase the range of sensitivity than would otherwise be achieved by utilizing a plurality of smaller sensor lines separately connected.

When the touch controller is operating in this first mode, it may detect an object within the proximity of the screen, as illustrated in operation 907. At this point, the object (e.g., finger) may not have made contact with the touch screen yet. Once this event is detected, the touch controller can switch to operating in a second mode, as shown in operation 908. The second mode can be another sub-mode of the self-capacitance mode, where instead of interconnecting all sensor lines, only a sub-set of the sensor lines are interconnected together, thereby forming a number of quadrants. For example, every three or four rows and columns can be interconnected to produce a 4×4 grid, as illustrated in FIG. 7. Any number of quadrants can be produced by adjusting the number of connected rows/columns or other sensor lines. In various embodiments, dividing the touch screen in these logical quadrants can enable the touch controller to determine an approximate location of the object (e.g., finger) on the screen, as shown in operation 909.

In operation 910, the device can determine that the object is touching the screen and in response to this determination, the touch controller can switch to operate in a third mode, as shown in operation 911. In this example, the third mode can be a mutual capacitance mode that is capable of more precisely determining the location of multiple touches. For example, the mutual capacitance mode can use each column of the sensor grid as a transmitter and each row as the receiver to locate the touches, as previously described.

It should be noted that although FIG. 9B illustrates two sub-modes of the self-capacitance mode, any number of such sub-modes can be possible within the scope of various embodiments. For example, as the finger approaches the screen, the touch controller may switch between three or four sub-modes of the self-capacitance mode by first interconnecting every 5 rows, followed by interconnecting every 4 rows, then by connecting every 3 rows and so on. This would cause the screen to be subdivided into more and more quadrants, allowing the touch controller to locate the object with more and more precision. In this manner, the touch controller can change the granularity of precision detection by combining more or less rows/columns of the touch sensor lines.

In addition, a number of different sub-modes of the mutual capacitance is also possible within the scope of various embodiments, as described throughout this disclosure. For example, it is possible in a first sub-mode of mutual capacitance to utilize the top-most row as the transmitter and the bottom row as receiver, and then in a second sub-mode to utilize both the top row and bottom row as transmitters and utilize one or more middle rows to be a receiver and so on. Any number of such configurations are possible as will be evident to one of ordinary skill in the art based on the teachings of this disclosure.

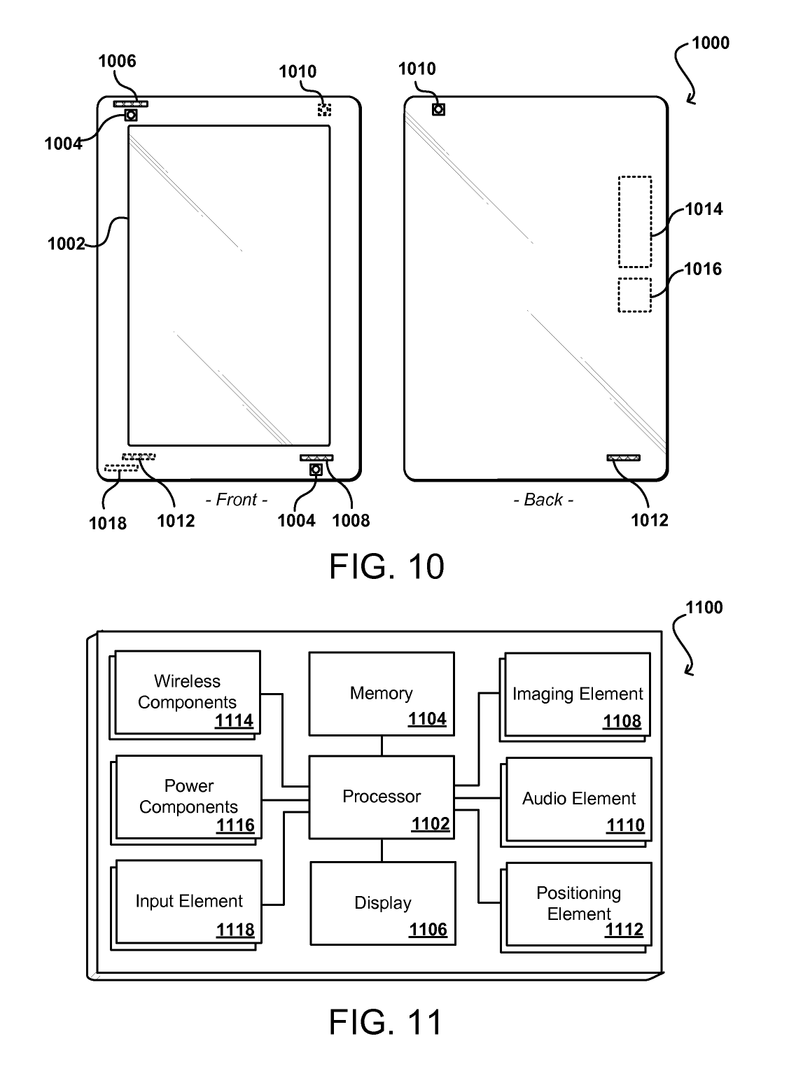

FIG. 10 illustrates front and back views of an example portable computing device 1000 that can be used in accordance with various embodiments. Although one type of portable computing device (e.g., a smart phone, an electronic book reader, or tablet computer) is shown, it should be understood that various other types of electronic devices that are capable of determining, processing, and providing input can be used in accordance with various embodiments discussed herein. The devices can include, for example, notebook computers, personal data assistants, cellular phones, video gaming consoles or controllers, and portable media players, among others.

In this example, the portable computing device 1000 has a display screen 1002 (e.g., a liquid crystal display (LCD) element) operable to display image content to one or more users or viewers of the device. In at least some embodiments, the display screen provides for touch or swipe-based input using, for example, capacitive or resistive touch technology. Such a display element can be used to, for example, enable a user to provide input by pressing on an area of the display corresponding to an image of a button, such as a right or left mouse button, touch point, etc. The device can also have touch and/or pressure sensitive material 1010 on other areas of the device as well, such as on the sides or back of the device. While in at least some embodiments a user can provide input by touching or squeezing such a material, in other embodiments the material can be used to detect motion of the device through movement of a patterned surface with respect to the material.

The example portable computing device can include one or more image capture elements for purposes such as conventional image and/or video capture. As discussed elsewhere herein, the image capture elements can also be used for purposes such as to determine motion and receive gesture input. While the portable computing device in this example includes one image capture element 1004 on the “front” of the device and one image capture element 1010 on the “back” of the device, it should be understood that image capture elements could also, or alternatively, be placed on the sides or corners of the device, and that there can be any appropriate number of capture elements of similar or different types. Each image capture element may be, for example, a camera, a charge-coupled device (CCD), a motion detection sensor, or an infrared sensor, or can utilize another image capturing technology.

The portable computing device can also include at least one microphone 1006 or other audio capture element capable of capturing audio data, such as may be used to determine changes in position or receive user input in certain embodiments. In some devices there may be only one microphone, while in other devices there might be at least one microphone on each side and/or corner of the device, or in other appropriate locations.

The device 1000 in this example also includes at least one motion or position determining element operable to provide information such as a position, direction, motion, or orientation of the device. These elements can include, for example, accelerometers, inertial sensors, electronic gyroscopes, electronic compasses, and GPS elements. Various types of motion or changes in orientation can be used to provide input to the device that can trigger at least one control signal for another device. The example device also includes at least one communication mechanism 1014, such as may include at least one wired or wireless component operable to communicate with one or more portable computing devices. The device also includes a power system 1016, such as may include a battery operable to be recharged through conventional plug-in approaches, or through other approaches such as capacitive charging through proximity with a power mat or other such device. Various other elements and/or combinations are possible as well within the scope of various embodiments.

In order to provide functionality such as that described with respect to FIG. 10, FIG. 11 illustrates an example set of basic components of a portable computing device 1100, such as the device 1000 described with respect to FIG. 10. In this example, the device includes at least one processor 1102 for executing instructions that can be stored in at least one memory device or element 1104. As would be apparent to one of ordinary skill in the art, the device can include many types of memory, data storage or computer-readable storage media, such as a first data storage for program instructions for execution by the processor 1102, the same or separate storage can be used for images or data, a removable storage memory can be available for sharing information with other devices, etc.

The device typically will include some type of display element 1106, such as a touch screen, electronic ink (e-ink), organic light emitting diode (OLED) or liquid crystal display (LCD), although devices such as portable media players might convey information via other means, such as through audio speakers. As discussed, the device in many embodiments will include at least one image capture element 1108, such as one or more cameras that are able to image a user, people, or objects in the vicinity of the device. In at least some embodiments, the device can use the image information to determine gestures or motions of the user, which will enable the user to provide input through the portable device without having to actually contact and/or move the portable device. An image capture element also can be used to determine the surroundings of the device, as discussed herein. An image capture element can include any appropriate technology, such as a CCD image capture element having a sufficient resolution, focal range and viewable area, to capture an image of the user when the user is operating the device.

The device, in many embodiments, will include at least one audio element 1110, such as one or more audio speakers and/or microphones. The microphones may be used to facilitate voice-enabled functions, such as voice recognition, digital recording, etc. The audio speakers may perform audio output. In some embodiments, the audio speaker(s) may reside separately from the device. The device, as described above relating to many embodiments, may also include at least one positioning element 1112 that provides information such as a position, direction, motion, or orientation of the device. This positioning element 1112 can include, for example, accelerometers, inertial sensors, electronic gyroscopes, electronic compasses, and GPS elements.

The device can include at least one additional input device 1118 that is able to receive conventional input from a user. This conventional input can include, for example, a push button, touch pad, touch screen, wheel, joystick, keyboard, mouse, trackball, keypad or any other such device or element whereby a user can input a command to the device. These I/O devices could even be connected by a wireless infrared or Bluetooth or other link as well in some embodiments. In some embodiments, however, such a device might not include any buttons at all and might be controlled only through a combination of visual and audio commands such that a user can control the device without having to be in contact with the device.

The example device also includes one or more wireless components 1114 operable to communicate with one or more portable computing devices within a communication range of the particular wireless channel. The wireless channel can be any appropriate channel used to enable devices to communicate wirelessly, such as Bluetooth, cellular, or Wi-Fi channels. It should be understood that the device can have one or more conventional wired communications connections as known in the art. The example device includes various power components 1116 known in the art for providing power to a portable computing device, which can include capacitive charging elements for use with a power pad or similar device as discussed elsewhere herein. The example device also can include at least one touch and/or pressure sensitive element 1118, such as a touch sensitive material around a casing of the device, at least one region capable of providing squeeze-based input to the device, etc. In some embodiments this material can be used to determine motion, such as of the device or a user's finger, for example, while in other embodiments the material will be used to provide specific inputs or commands.

In some embodiments, a device can include the ability to activate and/or deactivate detection and/or command modes, such as when receiving a command from a user or an application, or retrying to determine an audio input or video input, etc. In some embodiments, a device can include an infrared detector or motion sensor, for example, which can be used to activate one or more detection modes. For example, a device might not attempt to detect or communicate with devices when there is not a user in the room. If an infrared detector (i.e., a detector with one-pixel resolution that detects changes in state) detects a user entering the room, for example, the device can activate a detection or control mode such that the device can be ready when needed by the user, but conserve power and resources when a user is not nearby.

A computing device, in accordance with various embodiments, may include a light-detecting element that is able to determine whether the device is exposed to ambient light or is in relative or complete darkness. Such an element can be beneficial in a number of ways. In certain conventional devices, a light-detecting element is used to determine when a user is holding a cell phone up to the user's face (causing the light-detecting element to be substantially shielded from the ambient light), which can trigger an action such as the display element of the phone to temporarily shut off (since the user cannot see the display element while holding the device to the user's ear). The light-detecting element could be used in conjunction with information from other elements to adjust the functionality of the device. For example, if the device is unable to detect a user's view location and a user is not holding the device but the device is exposed to ambient light, the device might determine that it has likely been set down by the user and might turn off the display element and disable certain functionality. If the device is unable to detect a user's view location, a user is not holding the device and the device is further not exposed to ambient light, the device might determine that the device has been placed in a bag or other compartment that is likely inaccessible to the user and thus might turn off or disable additional features that might otherwise have been available. In some embodiments, a user must either be looking at the device, holding the device or have the device out in the light in order to activate certain functionality of the device. In other embodiments, the device may include a display element that can operate in different modes, such as reflective (for bright situations) and emissive (for dark situations). Based on the detected light, the device may change modes.

Using the microphone, the device can disable other features for reasons substantially unrelated to power savings. For example, the device can use voice recognition to determine people near the device, such as children, and can disable or enable features, such as Internet access or parental controls, based thereon. Further, the device can analyze recorded noise to attempt to determine an environment, such as whether the device is in a car or on a plane, and that determination can help to decide which features to enable/disable or which actions are taken based upon other inputs. If voice recognition is used, words can be used as input, either directly spoken to the device or indirectly as picked up through conversation. For example, if the device determines that it is in a car, facing the user and detects a word such as “hungry” or “eat,” then the device might turn on the display element and display information for nearby restaurants, etc. A user can have the option of turning off voice recording and conversation monitoring for privacy and other such purposes.

In some of the above examples, the actions taken by the device relate to deactivating certain functionality for purposes of reducing power consumption. It should be understood, however, that actions can correspond to other functions that can adjust similar and other potential issues with use of the device. For example, certain functions, such as requesting Web page content, searching for content on a hard drive and opening various applications, can take a certain amount of time to complete. For devices with limited resources, or that have heavy usage, a number of such operations occurring at the same time can cause the device to slow down or even lock up, which can lead to inefficiencies, degrade the user experience and potentially use more power.

In order to address at least some of these and other such issues, approaches in accordance with various embodiments can also utilize information such as user gaze direction to activate resources that are likely to be used in order to spread out the need for processing capacity, memory space and other such resources.

In some embodiments, the device can have sufficient processing capability, and the imaging element and associated analytical algorithm(s) may be sensitive enough to distinguish between the motion of the device, motion of a user's head, motion of the user's eyes and other such motions, based on the captured images alone. In other embodiments, such as where it may be desirable for the process to utilize a fairly simple imaging element and analysis approach, it can be desirable to include at least one orientation determining element that is able to determine a current orientation of the device. In one example, the at least one orientation determining element is at least one single- or multi-axis accelerometer that is able to detect factors such as three-dimensional position of the device and the magnitude and direction of movement of the device, as well as vibration, shock, etc. Methods for using elements such as accelerometers to determine orientation or movement of a device are also known in the art and will not be discussed herein in detail. Other elements for detecting orientation and/or movement can be used as well within the scope of various embodiments for use as the orientation determining element. When the input from an accelerometer or similar element is used along with the input from the camera, the relative movement can be more accurately interpreted, allowing for a more precise input and/or a less complex image analysis algorithm.

When using an imaging element of the computing device to detect motion of the device and/or user, for example, the computing device can use the background in the images to determine movement. For example, if a user holds the device at a fixed orientation (e.g. distance, angle, etc.) to the user and the user changes orientation to the surrounding environment, analyzing an image of the user alone will not result in detecting a change in an orientation of the device. Rather, in some embodiments, the computing device can still detect movement of the device by recognizing the changes in the background imagery behind the user. So, for example, if an object (e.g. a window, picture, tree, bush, building, car, etc.) moves to the left or right in the image, the device can determine that the device has changed orientation, even though the orientation of the device with respect to the user has not changed. In other embodiments, the device may detect that the user has moved with respect to the device and adjust accordingly. For example, if the user tilts their head to the left or right with respect to the device, the content rendered on the display element may likewise tilt to keep the content in orientation with the user.

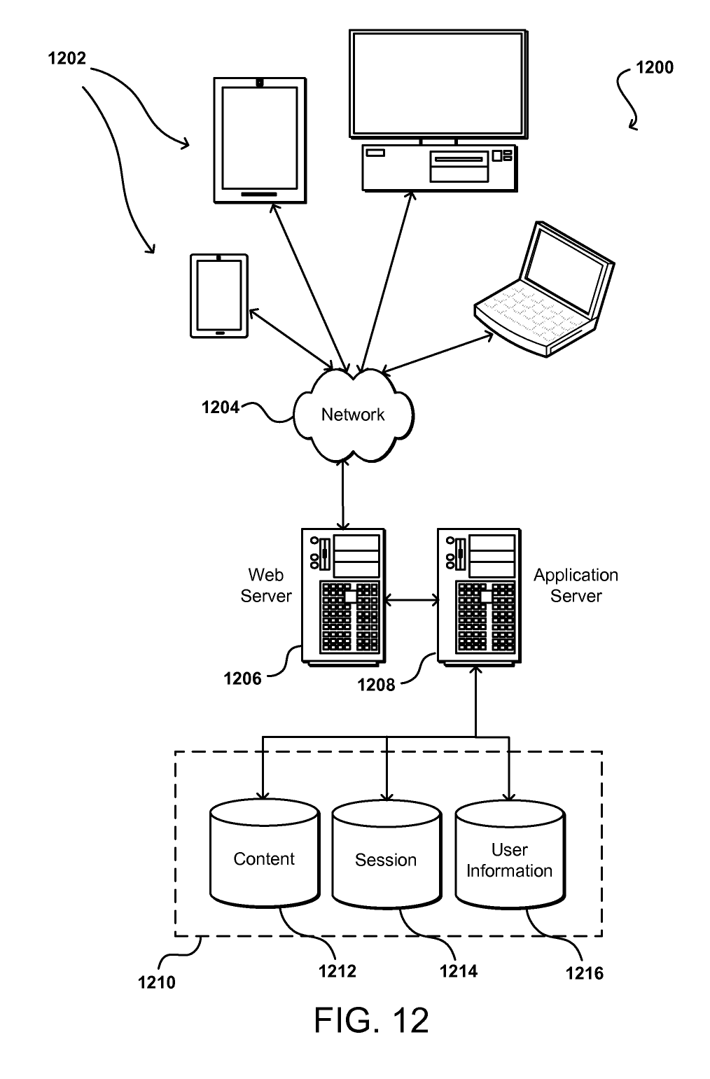

As discussed, different approaches can be implemented in various environments in accordance with the described embodiments. For example, FIG. 12 illustrates an example of an environment 1200 for implementing aspects in accordance with various embodiments. As will be appreciated, although a Web-based environment is used for purposes of explanation, different environments may be used, as appropriate, to implement various embodiments. The system includes an electronic client device (1218, 1220, 1222, 1224), which can include any appropriate device operable to send and receive requests, messages or information over an appropriate network 1204 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. The network could be a “push” network, a “pull” network, or a combination thereof. In a “push” network, one or more of the servers push out data to the client device. In a “pull” network, one or more of the servers send data to the client device upon request for the data by the client device. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server 1206 for receiving requests and serving content in response thereto, although for other networks, an alternative device serving a similar purpose could be used, as would be apparent to one of ordinary skill in the art.

The illustrative environment includes at least one application server 1208 and a data store 1210. It should be understood that there can be several application servers, layers or other elements, processes or components, which may be chained or otherwise configured, which can interact to perform tasks such as obtaining data from an appropriate data store. As used herein, the term “data store” refers to any device or combination of devices capable of storing, accessing and retrieving data, which may include any combination and number of data servers, databases, data storage devices and data storage media, in any standard, distributed or clustered environment. The application server 1208 can include any appropriate hardware and software for integrating with the data store 1210 as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server 1206 in the form of HTML, XML or another appropriate structured language in this example. The handling of all requests and responses, as well as the delivery of content between the client device (1218, 1220, 1222, 1224) and the application server 1208, can be handled by the Web server 1206. It should be understood that the Web and application servers are not required and are merely example components, as structured code discussed herein can be executed on any appropriate device or host machine as discussed elsewhere herein.

The data store 1210 can include several separate data tables, databases or other data storage mechanisms and media for storing data relating to a particular aspect. For example, the data store illustrated includes mechanisms for storing content (e.g., production data) 1212 and user information 1216, which can be used to serve content for the production side. The data store is also shown to include a mechanism for storing log or session data 1214. It should be understood that there can be many other aspects that may need to be stored in the data store, such as page image information and access rights information, which can be stored in any of the above listed mechanisms as appropriate or in additional mechanisms in the data store 1210. The data store 1210 is operable, through logic associated therewith, to receive instructions from the application server 1208 and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device (1218, 1220, 1222, 1224). Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 12. Thus, the depiction of the system 1200 in FIG. 12 should be taken as being illustrative in nature and not limiting to the scope of the disclosure.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS and AppleTalk. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Pert, Python or TCL, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A portable computing device, comprising:
a display screen;
at least one sensor layer having a first sensor and a second sensor for use in detecting changes in at least one of: capacitance or electric field, the changes caused by one or more objects coming to a proximity of the display screen, wherein the one or more objects modify both the capacitance and the electric field when in the proximity of the display screen; and
a touch controller configured to analyze the change to detect a presence of the one or more objects, the touch controller configured to:
operate in a self-capacitance mode by scanning the first sensor for changes in the capacitance of the first sensor and scanning the second sensor for changes in the capacitance of the second sensor;
detect a specified interaction of the one or more objects with the display screen based at least in part on the changes in the capacitance in the sensor layer; and
switch to operating in a mutual capacitance mode in response to detecting the specified interaction, wherein the touch controller operates in the mutual capacitance mode by scanning for the changes in the capacitance between the first sensor and the second sensor.

2. The portable computing device of claim 1, wherein the touch controller is further configured to:
monitor data related to the one or more objects that have been detected in proximity to the display touch screen over a period of time;
determine that the data satisfies a condition; and
modify a scan rate of the touch controller in response to determining that the data satisfies the condition.

3. The portable computing device of claim 1, wherein the specified interaction of the one or more objects with the display screen further includes:
an event that includes the one or more objects contacting the screen at least two times within a specified period of time.

4. The portable computing device of claim 1, wherein the specified interaction of the one or more objects with the display screen is user-configurable by a user selecting one of a plurality of events that cause the user to switch from the self-capacitance mode to the mutual capacitance mode.

5. A computing device, comprising:
a plurality of sensors including at least a first sensor and a second sensor for use in detecting changes in at least one of: capacitance or electrical field caused by one or more objects in proximity of the computing device; and
a touch controller configured to analyze the changes to determine a presence of the one or more objects, the touch controller operable to switch between at least:
a self-capacitance mode of operation in which the touch controller scans the first sensor for changes in the capacitance of the first sensor and scans the second sensor for changes in the capacitance of the second sensor; and
a mutual capacitance mode of operation in which the touch controller scans for changes in the capacitance between the first sensor and the second sensor.

6. The computing device of claim 4, wherein the self-capacitance mode further includes at least:
a first sub-mode, wherein all of the plurality of sensors are interconnected to form a single sensor used for detecting the one or more objects within the proximity of the computing device before the one or more objects make physical contact with the computing device; and
a second sub-mode, wherein a sub-set of the plurality of sensors is interconnected to form two or more quadrants of interconnected sensor lines, the quadrants used by the touch controller to determine an approximate location of the one or more objects;
wherein the touch controller is operable to switch between the first sub-mode and the second sub-mode.

7. The computing device of claim 6, wherein the touch controller switches between the first sub-mode and the second sub-mode in response to determining that a distance between the one or more objects and the computing device has decreased, or increased.

8. The computing device of claim 5, wherein the touch controller is further configured to switch between the self-capacitance mode and the mutual capacitance mode in response to detecting a specified event.

9. The computing device of claim 8, wherein the specified event is a double tap event that includes the one or more objects making physical contact with at least a portion of the computing device at least two times within a specified period of time.

10. The computing device of claim 5, wherein the touch controller is further configured to:
maintain data related to the one or more objects detected within the proximity of the computing device; and
adjust a scan rate for scanning the plurality of sensors in response to detecting that the data satisfies a condition.

11. The computing device of claim 10, wherein adjusting the scan rate further comprises:
determining that a number of touches detected by the touch controller over a specified period of time is less than a first threshold;
reducing the scan rate for scanning the plurality of sensor in response to detecting that the number of touches is less than the first threshold.

12. The computing device of claim 5, further comprising a display screen, wherein the plurality of sensors further includes:
a plurality of rows and a plurality of columns.

13. The computing device of claim 12, wherein when the touch controller operates in mutual capacitance mode, the plurality of columns are configured to be transmitters and the plurality of rows are configured to be receivers; and
wherein the touch controller determines location of the one or more objects by determining a change in the electrical field received by at least one of the receivers.

14. The computing device of claim 12, wherein a first row of the plurality of rows is configured to be a transmitter and wherein a second row of the plurality of rows is configured to be a receiver, the first row and the second row being separated by one or more unactivated rows.

15. The computing device of claim 12, wherein a first row and a first column are configured to be a transmitter and wherein a second row and a second column are configured to be a receiver; and
wherein the touch controller is capable of identifying the one or more objects in proximity of the computing device before the one or more objects have made physical contact with the device by measuring the change in electric signal transmitted by the transmitter and received by the receiver.

16. The computing device of claim 12, wherein the plurality of rows and the plurality of columns can be shorted together to produce a single sensor capable of being used by the touch controller for detecting the one or more objects in the proximity of the computing device without physical contact between the one or more objects and the computing device by measuring a change in the capacitance of the single sensor.

17. The computing device of claim 12, wherein at least one row and at least one column are connected to act as a single electrode.

18. The computing device of claim 5, wherein all of the plurality of sensors is contained in a single sensor layer.

19. The computing device of claim 5, wherein a first subset of the plurality of sensors is contained in a first sensor layer and a second subset of the plurality of sensors is contained in a second sensor layer.

20. The computing device of claim 5, further comprising a processor capable of executing an application, wherein the touch controller is further configured to operate in the self-capacitance mode when an application executing on the computing device does not need more than two concurrent touch inputs.

21. A computer-implemented method, comprising:
scanning, by a touch controller of a computing device, a first sensor for changes in capacitance of the first sensor and a second sensor for changes in capacitance of the second sensor the changes in the capacitance of the first sensor and the second sensor caused by one or more objects in proximity of the computing device;
detecting a specified event associated with the one or more objects based at least in part on the scanning the first sensor and the second sensor; and
in response to detecting the specified event, operating the touch controller to begin scanning for changes in capacitance at an intersection between the first sensor and the second sensor

22. The computer-implemented method of claim 21, further comprising:
detecting a second specified event by the touch controller; and
operating the touch controller to stop scanning for changes in the capacitance at the intersection between the first sensor and the second sensor and to begin scanning the first sensor for changes in the capacitance of the first sensor and the second sensor for the changes in the capacitance of the second sensor in response to detecting the second specified event.

23. The computer-implemented method of claim 21, further comprising:
monitoring data related to the one or more objects that have been detected in proximity to the computing device over a period of time;
determining that the data satisfies a condition; and
modifying a scan rate of scanning the first sensor and the second sensor by the touch controller in response to determining that the one or more statistics have satisfied the condition.

24. The computer-implemented method of claim 21, wherein the specified event is a double tap event that includes the one or more objects making physical contact with the computing device at least two times within a specified period of time.

25. A non-transitory computer readable storage medium storing one or more sequences of instructions executable by one or more processors to perform a set of operations comprising:
scanning a first sensor for changes in capacitance of the first sensor and a second sensor for changes in capacitance of the second sensor, the changes in the capacitance caused by one or more objects in proximity of the computing device;
detecting a specified event associated with the one or more objects based at least in part on the scanning the first sensor and the second sensor; and
in response to detecting the specified event, scanning an intersection between the first sensor and the second sensor for changes in capacitance.

26. The non-transitory computer readable storage medium of claim 25, further comprising instructions executable by the one or more processors to perform the operations of:
detecting a second specified event; and
in response to detecting the second specified event, suspending the scanning of the intersection between the first sensor and the second sensor and resuming the scanning of the first sensor for the changes in the capacitance of the first sensor and the second sensor for changes in the capacitance of the second sensor in response to detecting the second specified event.

27. The non-transitory computer readable storage medium of claim 25, further comprising instructions executable by the one or more processors to perform the operations of:
monitoring data related to the one or more objects that have been detected in proximity to the computing device over a period of time;
determining that the data satisfies a condition; and
modifying a scan rate of scanning the first sensor and the second sensor in response to determining that the data satisfies the condition.

28. The non-transitory computer readable storage medium of claim 25, wherein the specified event is a double tap event that includes the one or more objects making physical contact with the computing device at least two times within a specified period of time.

29. The non-transitory computer readable storage medium of claim 25, wherein the computing device further includes a display screen and wherein the plurality of sensors further includes a plurality of rows and a plurality of columns.
